(19) United States
(12) Patent Application Publication
(10) Pub. No.: US 2007/0195161 A1
(43) Pub. Date: Aug. 23, 2007

(54) IMAGE PROCESSING SYSTEM, DISPLAY DEVICE, PROGRAM, AND INFORMATION STORAGE MEDIUM

(75) Inventor: Eiji NAKAYA, Tatsuno-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/677,379

(22) Filed: Feb. 21, 2007

(30) Foreign Application Priority Data
Feb. 23, 2006 (JP) 2006-047091

(51) Int. Cl. H04N 13/00

(52) U.S. Cl. 348/43

(57) ABSTRACT

An image processing system for stereoscopic view using a parallax barrier method, includes an image information generation section that generates image information composed of the number of pixels corresponding to a lower resolution than an actual resolution for every viewpoint of a first through an nth (n is an integer one of equal to and larger than two) viewpoints, a screen buffer divided as dedicated areas respectively corresponding to the first through the nth viewpoints, a transmission section that transmits the image information to each of the dedicated areas in the screen buffer, and an output section that outputs an image signal to a liquid crystal panel in accordance with the image information transmitted to each of the dedicated areas in the screen buffer.

### BACKGROUND

1. Technical Field

The present invention relates to an image processing system, a display device, a program, and an information storage medium for stereoscopic vision using a parallax barrier method.

2. Related Art

In JP-A-2004-334550, for example, there is described a stereoscopic image processing method for stereoscopic vision using a parallax barrier method provided with a parallax barrier corresponding to each of subpixels.

In the method in the related art such as described in the above document, it is required to perform rendering of image data as many as the number of the whole pixels for every viewpoint.

However, in the case of the stereoscopic view using the parallax barrier method, what is actually viewed as a stereoscopic image is an image composed of the effective pixel number of pixels, which is fewer than the total pixel number. For example, in the case of stereoscopic view using a for-view point stepwise parallax barrier method, if the size of the total pixels is 800 pixels in the horizontal direction by 600 pixels in the vertical direction, the size of the effective pixels is 600 pixels in horizontal direction by 200 pixels in vertical direction.

In essence, in the method in the related art, the rendering and so on for the image data as many as the total pixel number is performed for every viewpoint, thus causing waste in the image processing.

### SUMMARY

An advantage of the invention is to provide an image processing system, a display device, a program, and an information storage medium capable of performing image processing more efficiently in image processing of the stereoscopic view using the parallax barrier method.

According to an aspect of the invention, there is provided an image processing system for stereoscopic view using a parallax barrier method including an image information generation section that generates image information composed of the number of pixels corresponding to a lower resolution than an actual resolution for every view-point of a first through an nth (n is an integer one of equal to and larger than two) viewpoints, a screen buffer divided as dedicated areas respectively corresponding to the first through the nth viewpoints a transmission section that transmits the image information to each of the dedicated areas in the screen buffer, and an output section that outputs an image signal to a liquid crystal panel in accordance with the image information transmitted to each of the dedicated areas in the screen buffer.

Further, according to another aspect of the invention there is provided a program for instructing a computer provided with a display device including a liquid crystal panel for stereoscopic view using a parallax barrier method and a screen buffer divided as dedicated areas respectively corresponding to a first through nth (n is an integer one of equal to and larger than two) viewpoints to function as an image information generation section that generates image information composed of the number of pixels corresponding to a lower resolution than an actual resolution for every viewpoint of the first through the nth viewpoints, a transmission section that transmits the image information to each of the dedicated areas in the screen buffer, and an output section that outputs an image signal to the liquid crystal panel in accordance with the image information transmitted to each of the dedicated areas in the screen buffer.

Further, according to another aspect of the invention, there is provided a computer-readable information storage medium for storing the program described above.

According to the above aspects of the invention, the image processing system and so on generate the image information composed of the pixels with a resolution lower than the actual resolution to transmit it to the screen buffer for every viewpoint, and then outputs the image signal to the liquid crystal panel in accordance with the image information transmitted to the screen buffer, thereby reducing the load of the process such as the rendering compared to the case in which the rendering corresponding to the number of the actual pixels is performed as in the related art. Thus, the image processing system and so on can more efficiently perform image processing in the image processing for the stereoscopic view using the parallax barrier method.

Further, the number of the pixels corresponding to the lower resolution, assuming that a displayed image using the parallax barrier method is observed as stereoscopic view simultaneously observed by at least the right and the left eyes as different images, can be the number of pixels obtained by dividing the number of the total pixels composing the whole displayed image by the number of viewpoints n.

Still further, the image information generation section can generate the image information by rendering.

Thus, the image processing system and so on can reduce the processing load by performing the rendering with a lower resolution compared to the case in which the rendering is performed with the actual resolution.

Further, it is possible that the output section simultaneously refers to the dedicated areas in the screen buffer in accordance with mask patterns respectively corresponding to the viewpoints, and combines components of subpixels to output the image signal to the liquid crystal panel so that a stereoscopic image is observed.

Thus, the image processing system and so on can appropriately judge which pixel data for which one of the viewpoints is required to be transmitted to the screen buffer in accordance with the mask patterns.

Further, the image processing system and the computer can further include a plurality of line buffers each corresponding to the respective viewpoints and capable of performing reading/writing operations at a higher speed than the screen buffer, and the output section can transmit partial information corresponding to one through several lines included in the image information stored in the dedicated areas in the screen buffer to the line buffers assigned to the respective viewpoints while outputting the partial information to the liquid crystal panel as the image information obtained by combining the components of subpixels in accordance with the mask patterns corresponding to the respective viewpoints.

Thus, the image processing system and so on can manage the image information for every line buffer, and accordingly, perform the image processing more efficiently.

Further, according to another aspect of the invention, there is provided a display device having the image processing system described above, including a liquid crystal panel provided with the parallax barrier corresponding to each of the subpixels, wherein the mask patterns are set in accordance with positions of the parallax barriers.

According to this aspect of the invention, the display device can perform the image processing for subpixels as a unit using the mask patterns set in accordance with the positions of the parallax barriers.

### BRIEF DESCRIPTION OF THE DRAWINGS

The invention will now be described with reference to the accompanying drawings, wherein like numbers refer to like elements.

FIG. 1 is a functional block diagram of a display device in the present embodiment.

FIG. 2 is a hardware block diagram of a display device in the present embodiment.

FIG. 3 is a flowchart showing an image processing procedure in the related art.

FIG. 4 is a flowchart showing an image processing procedure of the present embodiment.

FIG. 5 is a schematic diagram showing a pixel group for a first viewpoint.

FIG. 6 is a schematic diagram showing a pixel group for a second viewpoint.

FIG. 7 is a schematic diagram showing a pixel group for a third viewpoint.

FIG. 8 is a schematic diagram showing a pixel group for a fourth viewpoint.

FIG. 9 is a schematic diagram showing an example of a pixel arrangement in a dedicated area to a first viewpoint.

FIG. 10 is a schematic diagram showing an example of a pixel arrangement in a liquid crystal panel.

FIG. 11 is a schematic diagram of stereoscopic view using a two-viewpoint parallax barrier method.

FIG. 12 is a schematic diagram of stereoscopic view using a four-viewpoint parallax barrier method.

### DESCRIPTION OF EXEMPLARY EMBODIMENTS

Hereinafter, the present invention will be explained on a case where it is applied to a display device as an example with reference to the accompanying drawings. Note that the embodiments described below do not at all limit contents of the invention as described in the appended claims. Further, not necessarily all of the components shown in the embodiments below are indispensable as the means for solution of the invention described in the appended claims.

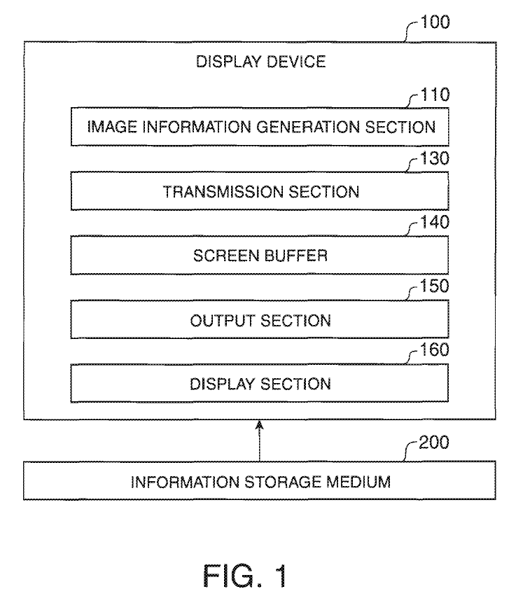

FIG. 1 is a functional block diagram of a display device 100 in the present embodiment.

The display device 100 is configured including an image information generation section 110 for generating image information composed of pixels having the number corresponding to a lower resolution than the actual resolution for each of a first through nth (n is an integer equal to or larger than two) viewpoints the screen buffer 140 divided into dedicated areas respectively corresponding to the first through nth viewpoints, a transmission section 130 for transmitting the image information to the screen buffer 140, an output section 150 for outputting an image signal to a liquid crystal panel in accordance with the image information transmitted to the screen buffer 140, and a display section 160 including the liquid crystal section 160.

It should be noted that the image information generation section 110, the transmission section 130, the screen buffer 140, and the output section 150 also function as an image processing system for stereoscopic view using a parallax barrier method.

Further, the display device 100 can implement the functions of these sections by retrieving a program from an information storage medium 200.

It should be noted that a storage medium using laser, magnetism, or the like such as CD-ROM, DVD-ROM, IC card, ROM, RAM, memory card, and HDD can be applied as the information storage medium 200. Further, the method of retrieving the program from the information storage medium 200 can be a contact method or noncontact method. Still further, the display device 100 can implement the functions of these sections by downloading the program via a network.

Further, as the hardware for implementing these sections, the following can be adopted.

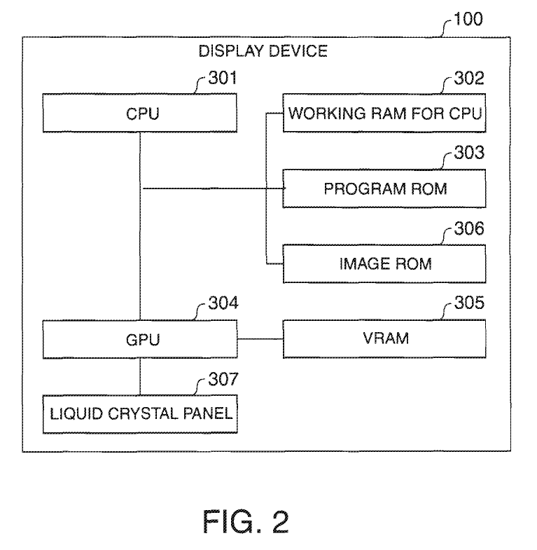

FIG. 2 is a hardware block diagram of the display device in the present embodiment.

The display device 100 is configured including, for example, a CPU 301, a working RAM 302 for a CPU; a program ROM 303, a GPU 304, a VRAK 305, an image ROM 306, and a liquid crystal panel 307.

For example, the functions of the image information generation section 110, the transmission section 130, and the output section 150 can be implemented by the CPU 304, the function of the screen buffer 140 can be implemented by the VRAM 305, and the function of the display section 160 can be implemented by the liquid crystal panel 307, respectively. Further, a part of the function of the image information generation section 110 can be implemented by the CPU 301, and a part of the function of the transmission section 130 can be implemented by the working RAM 302 and the program ROM

Still further, the liquid crystal panel 307 is a liquid crystal panel for stereoscopic view provided with a parallax barrier. It should be noted that as the number of assumed viewpoints, any integers (e.g., two, four, or seven) equal to or larger than two can be adopted.

Still further, the liquid crystal panel 307 is a liquid crystal panel for stereoscopic view provided with a parallax barrier corresponding to each of the subpixels. Here, the stereoscopic view in the cases of with two viewpoints and four viewpoints will be explained.

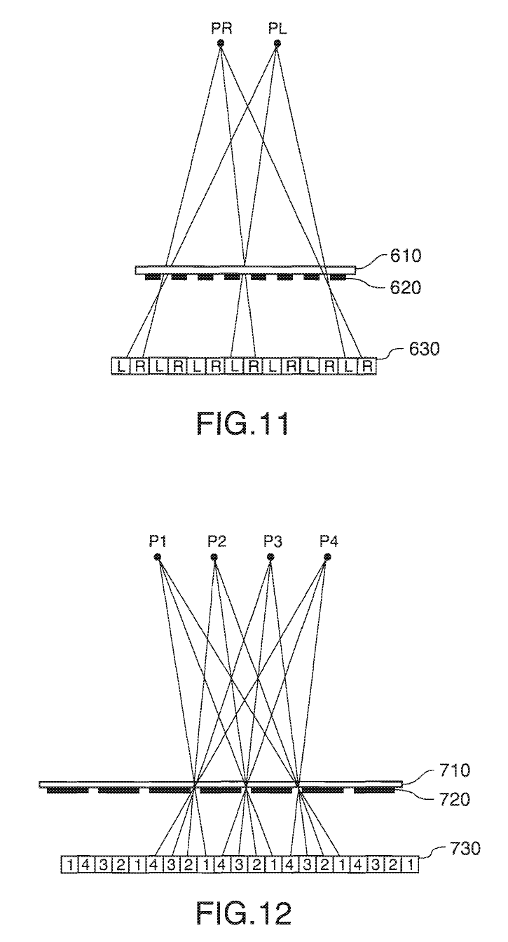

FIG. 11 is a schematic diagram of the stereoscopic view using a two-viewpoint parallax barrier method. Further, FIG. 12 is a schematic diagram of the stereoscopic view using a four-viewpoint parallax barrier method.

In the case with the two viewpoints, an opaque parallax barrier 620 is disposed in front of an LCD 630, and the observer observes via a lens filter 610 pixels R for the right eye at the first viewpoint (PR) for the right eye, and pixels L for the left eye at the second viewpoint (PL) for the left eye, thus the stereoscopic view is realized. It should be noted that the parallax barrier 620 can be disposed behind the LCD 630.

Further, in the case with the four viewpoints, similarly to the case with the two viewpoints, an opaque parallax barrier 720 is disposed in front of an LCD 730, and the observer observes via a lens filter 710 either sets of first pixels through fourth pixels at either two adjacent viewpoints of the first viewpoint (P1) second view-point (P2), third viewpoint (P3), and fourth viewpoint (P4), thus the stereoscopic view is realized. It should be noted that the parallax barrier 720 can be disposed behind the LCD 730.

Hereinafter, explanations will be presented taking 3D image processing in the case with four viewpoints as an example.

Firstly, an image processing procedure in the related art from setup of a 3D model to display of the image will be explained.

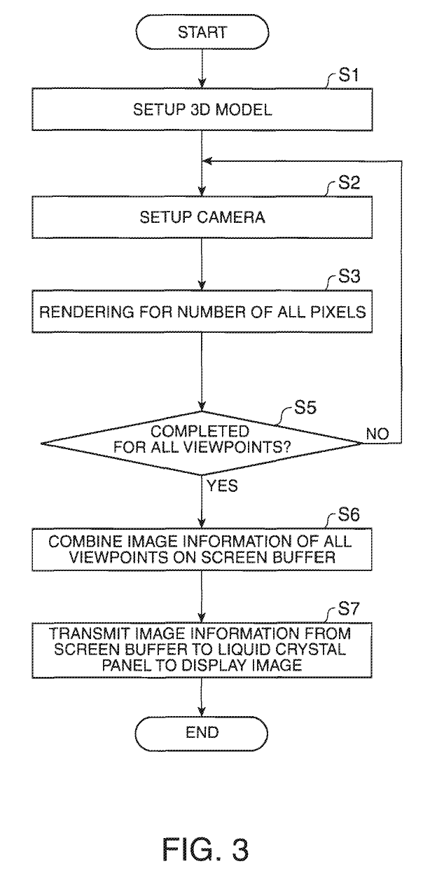

FIG. 3 is a flowchart showing an image processing procedure in the related art.

The display device in the related art performs setup (vertex calculation, transmission of the vertex data and texture data) of a 3D model when renewing the image (step S1).

Further, the display device performs setup of a camera (step S2), and then performs rendering corresponding to the number of all of the pixels (e.g., 480000 pixels in the liquid crystal panel with the actual resolution of 800 by 600 pixels) (step S3).

Further, the display device performs the steps S2 and S3 for every viewpoint until the processes for all viewpoints are completed (step S5). Specifically, in the case with the four viewpoints, the rendering for 1920000 pixels is performed in the above example.

Subsequently, after the rendering for all of the viewpoints has completed, the display device combines (step S6) the image information for all of the viewpoints after the rendering in the screen buffer, and transmits the image information to the liquid crystal panel to display (step S7) the image thereon.

In contrast, the display device 100 of the present embodiment reduces the time necessary for performing the rendering in comparison with the related art by performing the rendering corresponding to the number of effective pixels.

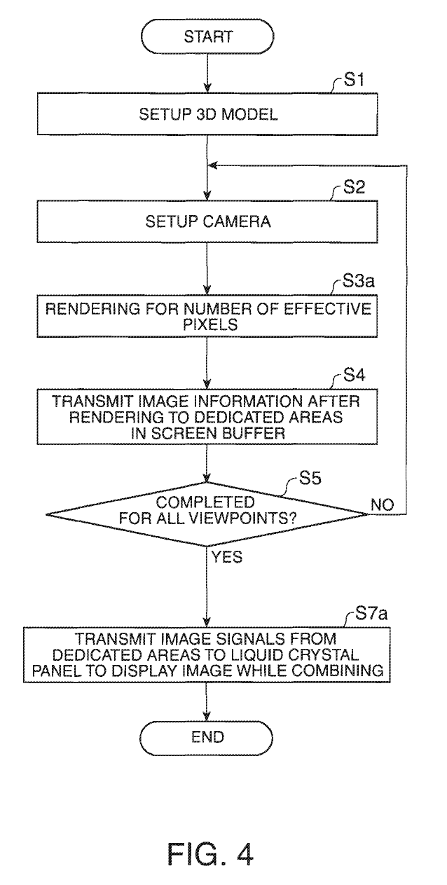

FIG. 4 is a flowchart showing an image processing procedure of the present embodiment.

The CPU 301 performs setup (vertex calculation, transmission of the vertex data and texture data) of a 3D model when renewing the image (step S1).

Further, the image information generation section 110 (GPU 304) performs setup of a camera (step S2) and then performs rendering corresponding to the number of the effective pixels (the number of pixels obtained by dividing the number of total pixels composing the whole displayed image by the number of viewpoints n in the case in which the displayed image using the parallax barrier method is observed as the stereoscopic view simultaneously observed by at least the right and the left eyes as different images; e.g., in the liquid crystal panel with 800 by 600 pixels, the number of the effective pixels or the effective resolution is 600×200=120000 pixels) (step S3a).

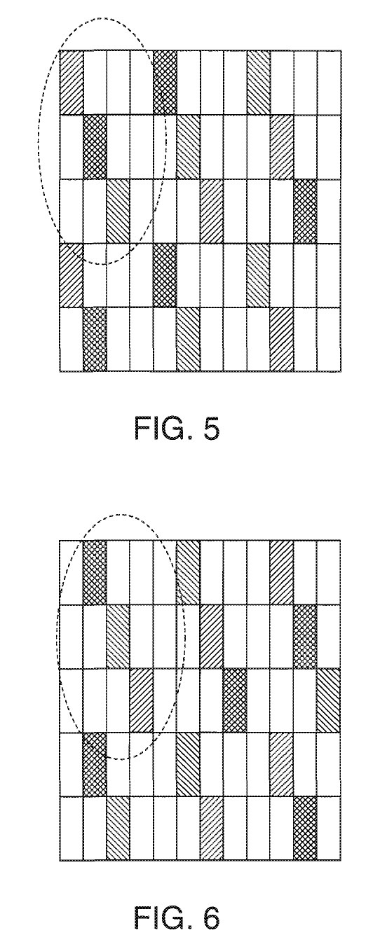

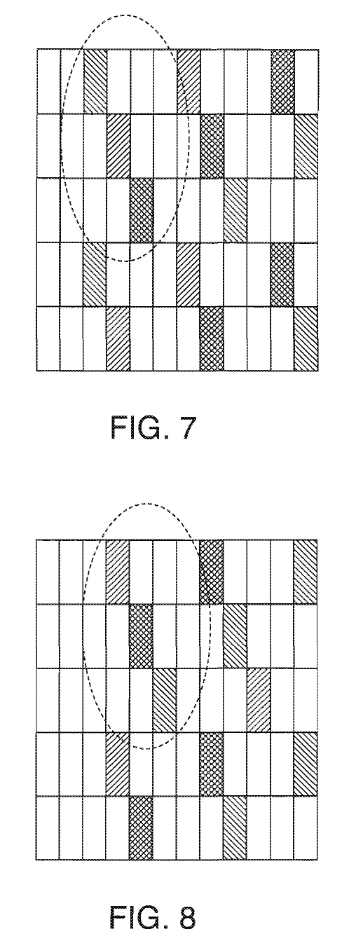

FIG. 5 is a schematic diagram showing a pixel group for the first viewpoint. Further, FIG. 6 is a schematic diagram showing a pixel group for the second viewpoint. Further, FIG. 7 is a schematic diagram showing a pixel group for the third viewpoint. Further, FIG. 8 is a schematic diagram showing a pixel group for the fourth view-point. It should be noted that the pixel groups shown in FIGS. 5 through 8 each show only a part or the image.

In the present embodiment, a stepwise parallax barrier method is adopted. For example, as shown in FIG. 5, R pixels (hatched portions with lines slanted up to the right), G pixels (cross-hatched portions), and B pixels (hatched portions with lines slanted up to the left) are disposed at a slant, and each pixel in the first viewpoint is formed with the three subpixels. Further, the portion surrounded by a broken line is a pixel for the first viewpoint corresponding to the coordinate (0,0) in the effective resolution.

Further, as is apparent from the comparison between FIGS. 5 through 8, the right-hand neighbor of each of the pixels for the first viewpoint is used as the pixel for the second viewpoint, the right-hand neighbor of each of the pixels for the second viewpoint is used as the pixel for the third viewpoint, and the right-hand neighbor of each of the pixels for the third viewpoint is used as the pixel for the fourth viewpoint.

Further, in the case with the four-viewpoint stepwise parallax barrier method, the effective resolution (the number of the effective pixels) becomes three-quarter resolution in the horizontal direction and a third resolution in the vertical direction. Therefore, assuming the total pixels of the liquid crystal pane 307 are 800 by 600 pixels, the number of the effective pixels becomes 600 by 200 pixels.

Further, the image information generation section 110 transmits the image information for every viewpoint to the dedicated area to the respective one of the viewpoints in the screen buffer 140 (step S4).

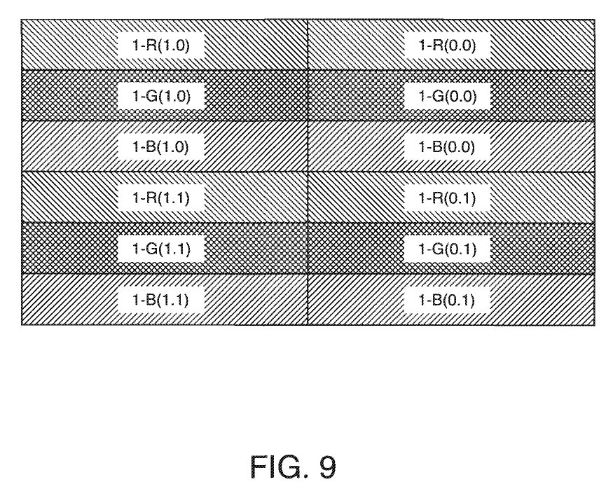

FIG. 9 is a schematic diagram showing an example of a pixel arrangement in the dedicated area to the first viewpoint.

In the dedicated area to the first viewpoint, the image information for every subpixel is disposed in the order of, for example, the R pixel, G pixel, and B pixel in the coordinate (0,0) in the effective resolution, the R pixel, G pixel, and B pixel in the coordinate (0,1) the R pixel, G pixel, and B pixel in the coordinate (0,2), and so on. It should be noted that the same applies to the dedicated areas to the second viewpoint, the third viewpoint, and the fourth viewpoint, respectively.

Further, the display device 100 performs the steps S2 through S4 for every viewpoint until the processes for all viewpoints are completed (step S5). Specifically, in the case with the four viewpoints, the rendering for 600×200×4=480000 pixels is performed in the above example.

Subsequently, after completion of the rendering for all of the viewpoints, the output section 150 simultaneously refers to the dedicated areas in the screen buffer 140 in accordance with a mask pattern corresponding to each of the viewpoints to output to the liquid crystal panel the image signal obtained by combining the components of the subpixels in the respective dedicated areas so that the stereoscopic image can be observed, thus displaying the image while combining the image (step S7a). It should be noted that data for representing the mask pattern (more specifically, a pixel mask or color mask, for example) is generated in accordance with the parallax barrier, and is stored in the image ROM 306 or the like.

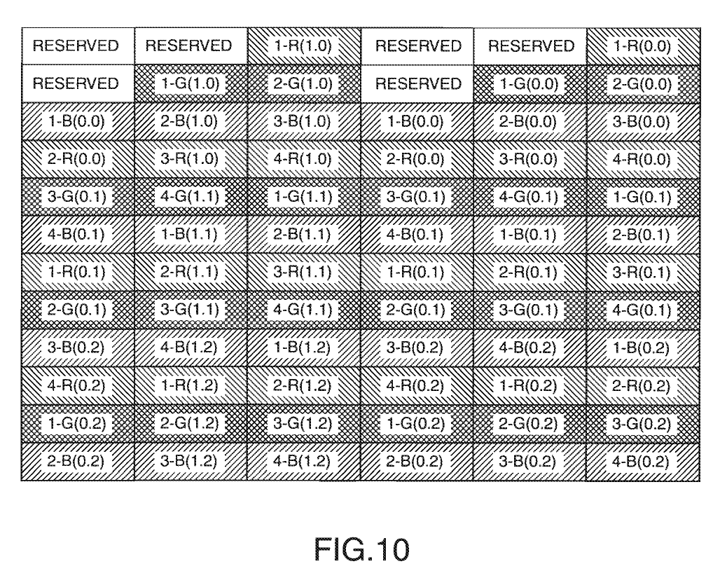

FIG. 10 is a schematic diagram showing an example of a pixel arrangement in the liquid crystal panel 307. It should be noted that the pixel arrangement shown in FIG. 10 shows only a part of the image.

In FIG. 10, “1-R(0,0)” denotes the R pixel for the first viewpoint at the coordinate (0,0) in the effective resolution. For example, the subpixels are disposed in such an order as “1-R(0,0),” “2-G(0,0),” “3-B(0,0),” “4-R(0,0),” “1-G(0,1),” “2-B(0,1),” from the upper left of the liquid crystal panel 307.

Accordingly, since the resolution n the rendering is different from the related art, but the resolution on the display (the pixel arrangement of the liquid crystal panel 307) is the same as the related art, the display device 100 can display the image with an appropriate resolution.

Further, as described above, since the arrangement position of the subpixels in the liquid crystal panel 307 is fixed, and the arrangements of the subpixels in the dedicated areas in the screen buffer 140 are also fixed, the output process by the output section 150 can be performed by a hardware logic circuit, thus the output process can be performed at a higher speed compared to the case in which the process is performed by a software manner.

Further, according to the present embodiment, the display device 100 generates the image information composed of the pixels with the effective resolution lower than the actual resolution to transmit it to the screen buffer 140 for every viewpoint, and then outputs the image signal in accordance with the image information transmitted to the screen buffer 140, thereby reducing the load of the process such as the rendering compared to the case in which the rendering corresponding to the number of the actual pixels is performed as in the related art. More specifically, although the number of times of the rendering is 1.92 million times in the method of the related art, in the present embodiment described above, it is 0.48 times, which is a quarter thereof.

Thus, the display device 100 can reduce the load of the image processing such as the rendering in the image processing of the stereoscopic view using the parallax barrier method, making it possible to more efficiently perform the image processing. Further, the reduction of the image processing load causes the power consumption of the display device 100 to be suppressed, thus contributing to energy saving.

Further, according to the present embodiment, the display device 100 can perform the image processing for subpixels as a unit using the mask patterns set n accordance with the positions of the parallax barriers

It should be noted that applications of the present invention is not limited to the embodiment described above, but various modifications thereof are possible.

For example, although in the embodiment described above the display device 100 uses only the screen buffer 140, a line buffer not shown can also be used in conjunction therewith.

Specifically, it is also possible to provide the display device 100 with a line buffer capable of performing read/write operations at a higher speed than the screen buffer 140 for every viewpoint

Further, it is also possible that the output section 150 transmits the partial information corresponding to one through several lines included in the image information stored in the dedicated areas in the screen buffer 140 to the line buffers assigned to the respective viewpoints while outputting the partial information to the liquid crystal panel as the image information obtained by combining the components of the subpixels in accordance with the mask patterns corresponding to the respective viewpoints.

According to the above configuration, by using the line buffers, the display device 100 can manage the image information for every line buffer as a unit, and moreover it can use the line buffers as cash memories or FIFO memories, thus making the output process by the output section 150 more efficient.

Further, although in the embodiment described above the image information generation section 110 generates the image information composed of the number of pixels of the effective resolution, any resolutions lower than the actual resolution are sufficient, and the resolution is not limited to the effective resolution.

Further, the parallax barrier of the liquid crystal panel 307 is not limited to one having the stepwise (slanted) configuration, but the parallax barrier disposed at a constant interval in one direction can be adopted. In other words, the arrangement of the subpixels is not limited to the example shovel in FIGS. 6 through 8.

It should be noted that various devices such as a game machine such as a pinball machine or a slot machine, a game console, a liquid crystal display, or a PC integrated with a liquid crystal display specifically correspond to the display device 100 described above. Further, the function of the display device 100 can be implemented in a number of devices (e.g., a PC and a liquid crystal display) in a distributed manner.

The entire disclosure of Japanese Patent Application No. 2006-047091, filed Feb. 23, 2006 is expressly incorporated by reference herein.

What is claimed is:

1. An image processing system for stereoscopic view using a parallax barrier method, comprising:
an image information generation section that generates image information composed of the number of pixels corresponding to a lower resolution than an actual resolution for every viewpoint of a first through an nth (n is an integer one of equal to and larger than two) viewpoints;
a screen buffer divided as dedicated areas respectively corresponding to the first through the nth viewpoints;
a transmission section that transmits the image information to each of the dedicated areas in the screen buffer; and
an output section that outputs an image signal to a liquid crystal panel in accordance with the image information transmitted to each of the dedicated areas in the screen buffer.

2. The image processing system according to claim 1,
wherein
the number of the pixels corresponding to the lower resolution is, assuming that a displayed, image using the parallax barrier method is observed as stereoscopic view simultaneously observed by at least the right and the left eyes as different images, the number of pixels obtained by dividing the number of the total pixels composing the whole displayed image by the number of viewpoints n.

3. The image processing system according to claim 1,
wherein
the image information generation section generates the image information by rendering.

4. The image processing system according to claim 1,
wherein
the output section simultaneously refers to the dedicated areas in the screen buffer in accordance with mask patterns respectively corresponding to the viewpoints, and combines components of subpixels to output the image signal to the liquid crystal panel so that a stereoscopic image is observed.

5. The image processing system according to claim 1,
further comprising
a plurality of line buffers each corresponding to the respective viewpoints and capable of performing reading/writing operations at a higher speed than the screen buffer,
wherein,
the output section transmits partial information corresponding to one through several lines included in the image information stored in the dedicated areas in the screen buffer to the line buffers assigned to the respective viewpoints while outputting the partial information to the liquid crystal panel as the image information obtained by combining the components of subpixels in accordance with mask patterns corresponding to the respective viewpoints.

6. A display device including the image processing system according to claim 4, comprising
a liquid crystal panel provided with the parallax barrier corresponding to each of the subpixels,
wherein
the mask patterns are set in accordance with positions of the parallax barriers.

7. A program for instructing a computer provided with a display device including a liquid crystal panel for stereoscopic view using a parallax barrier method and a screen buffer divided as dedicated areas respectively corresponding to a first through nth (n is an integer one of equal to and larger than two) viewpoints to function as:
an image information generation section that generates image information composed of the number of pixels corresponding to a lower resolution than an actual resolution for every viewpoint of the first through the nth viewpoints;
a transmission section that transmits the image information to each of the dedicated areas in the screen buffer; and
an output section that outputs an image signal to the liquid crystal panel in accordance with the image information transmitted to each of the dedicated areas in the screen buffer.

8. A computer-readable information storage medium for storing the program according to claim 7.
